(19) United States
(12) Patent Application Publication
(10) Pub. No.: US 2019/0055710 A1
(43) Pub. Date: Feb. 21, 2019

(54) NONMETALLIC CONDUCTIVE GEOTEXTILE AND GEOCOMPOSITE

(71) Applicant: KANG GAO, SHENZHEN (CN)

(72) Inventor: KANG GAO, SHENZHEN (CN)

(21) Appl. No.: 15/972,180

(22) Filed: May 6, 2018

(30) Foreign Application Priority Data
Aug. 18, 2017 (CN) 2017107126610

(51) Int. Cl. E02D 17/20; H01B 12/00; H01B 1/04; H01B 5/14; B32B 5/02; B32B 5/26; B32B 27/08; D06M 11/74; D01F 1/10

(52) U.S. Cl. CPC E02D 17/202; H01B 12/00; H01B 1/04; H01B 5/14; B32B 5/022; H01B 1/124; B32B 5/028; B32B 27/08; D06M 11/74; D01F 1/10; B32B 5/26

(57) ABSTRACT

A nonmetallic conductive geotextile and a geocomposite. The nonmetallic conductive geotextile comprises a geotextile and a nonmetallic conductive structure, the nonmetallic conductive structure comprising one of carbon nanotube, graphene, superconductive carbon black or a combination thereof, wherein the nonmetallic conductive structure may be conductive coating which is coated onto the surface of the geotextile; the nonmetallic conductive structure may also be a conductive fiber, and when producing the geotextile, the conductive fiber is added and connected into the geotextile to form a nonmetallic conductive blended geotextile; the nonmetallic conductive structure may also be a conductive sewing thread, and when producing the geotextile, the conductive sewing thread is sewn onto a nonwoven fabric at regular intervals to form a nonmetallic conductive geotextile; and the geocomposite comprises a geonet and the nonmetallic conductive geotextile bonded to one surface or two surfaces of the geonet.

### BACKGROUND OF THE PRESENT INVENTION

### Field of Invention

The present invention relates to the technical field of geomembrane leakage-proof engineering, in particular to the technical field of leakage detection and long-term leakage monitoring in geomembrane leakage-proof engineering, specifically a nonmetallic conductive geotextile and a geocomposite.

### COPYRIGHT DECLARATION

The content disclosed by the present disclosure document contains materials protected by the copyright. The copyright belongs to the copyrighter. The copyrighter does not object to anybody copying the patent document or the patent disclosure existing in official records and files of the Patent & Trademark Office.

### Description of Related Arts

In the containment engineering of geomembranes, leakage is caused due to damages of the geomembranes. In environmental protection engineering, leaking liquid or solid will pollute surrounding environments and cause environmental disasters; and in hydrometallurgy, leaking solution not only will pollute the environment, but also will cause economic losses. Since the geomembranes may be damaged during production, transportation, construction and operation, it is necessary to found out damage holes of the geomembranes after completion and during operation to repair the holes of the geomembranes, so as to guarantee that completeness of the geomembranes and achieve zero leakage. Since a traditional containment structure possibly lacks for a necessary conductive layer, it is quite difficult for electrical leak location. Even though adopting corresponding engineering means, the detection accuracy cannot be guaranteed. In a long-term leakage monitoring system, since a dual-layer geomembranes structure lacks for a necessary conductive layer, conductive materials such as natural clay are adopted, and it is difficult and even impossible to construct natural clay on slopes. By using conductive geotextiles or conductive geocomposite having a conductive function, a uniform conductive layer can be formed below the geomembranes and through loophole detection after construction completion, tiny damages smaller than 1 mm can be found. In addition, in the long-term leakage monitoring system, the conductive geotextile or the conductive geocomposite replaces a common clay structure, a uniform conductive layer can be obtained, and it can be used even though on steep slopes.

Some existing conductive geotextiles use metals as conductive materials, metallic conductive materials themselves are very quickly corroded under acidic and alkaline environments, which will result in disappearing of conductive function. Metallic conductive materials also will be electrochemically corroded. Even though cathodic protection is adopted, it is very difficult to guarantee that thin metallic conductors can be effective in a long term. However, by adopting geotextiles made from nonmetallic conductive materials, the materials can be guaranteed to resist acid and alkali and electrochemical corrosion in long term use.

### SUMMARY OF THE PRESENT INVENTION

In view of the above-mentioned disadvantages of the prior art, the purpose of the embodiment of the present invention is to provide a nonmetallic conductive geotextile and a geocomposite, which are used for solving the problem that conductive geotextiles cannot resist acid and alkali and resist electrochemical corrosion when metals are used as conductive materials in the prior art.

In order to achieve the above-mentioned and other related purposes, the embodiment of the present invention provides a nonmetallic conductive geotextile comprising a geotextile and a nonmetallic conductive structure connected with the geotextile, and the nonmetallic conductive structure comprises one of carbon nanotube, graphene, superconductive carbon black or a combination thereof.

In one embodiment of the present invention, the nonmetallic conductive structure is conductive coating formed by mixture of one of the carbon nanotube, the graphene, the superconductive carbon black or a combination thereof, and a binder, and the conductive coating is coated onto one surface or two surfaces of the geotextile.

In one embodiment of the present invention, the conductive coating is coated onto the surface of the geotextile by means of spray coating, roller coating, roll coating, dip coating or brush coating to form a uniform conductive layer.

In one embodiment of the present invention, the surface resistivity of the conductive coating is smaller than 10⁵ ohms/square area.

In one embodiment of the present invention, the nonmetallic conductive structure is a conductive sewing thread formed by high-molecular polymer added with one of the carbon nanotube, the graphene, the superconductive carbon black or a combination thereof, or is a conductive sewing thread formed by a common sewing thread which is dip-coated with a high-molecular polymer added with one of the carbon nanotube, the graphene, superconductive carbon black or a combination thereof; and when producing geotextile, the conductive sewing thread is sewn onto a nonwoven fabric at regular intervals to form a nonmetallic conductive geotextile.

In one embodiment of the present invention, the sewing distance of the conductive sewing thread on the nonwoven fabric is 1 mm-500 mm; and the surface resistivity of the conductive sewing thread is smaller than 10⁵ ohms/square area.

In one embodiment of the present invention, the nonmetallic conductive structure is a conductive fiber formed by one of the carbon nanotube, the graphene, the superconductive carbon black or a combination thereof, and plastic particles; and when producing the geotextile, the conductive fiber is added and connected into the geotextile to form a nonmetallic conductive blended geotextile.

In one embodiment of the present invention, the content of the added conductive fiber is 5%-100%.

In one embodiment of the present invention, the surface resistivity of the nonmetallic conductive blended geotextile is smaller than 10⁵ ohms/square area.

The embodiment of the present invention further provides a geocomposite, the geocomposite comprises a geonet and the nonmetallic conductive geotextile bonded to one surface or two surfaces of the geonet; and when the nonmetallic conductive geotextile is bonded onto one surface of the geonet, a metallic conductive geotextile or nonconductive geotextile is bonded onto the other surface of the geonet.

As described above, the nonmetallic conductive geotextile and the geocomposite provided by the present invention have the following beneficial effects:

In the present invention, by connecting the nonmetallic conductive structure into the geotextile to form the nonmetallic conductive geotextile, the problem that geotextiles cannot resist acid and alkali and resist electrochemical corrosion when metals are used as conductive materials is avoided; in addition, in the present invention, by bonding the nonmetallic conductive geotextile onto the surface of the geonet to enable the geonet to form a uniform conductive layer, the geonet can be applied to the long-term monitoring of the geomembrane leakage-proof structure; and during damage loophole detection after construction, the accuracy of loophole detection can be effectively improved.

### BRIEF DESCRIPTION OF THE DRAWINGS

In order to more clearly describe the technical solution in the embodiment of the present invention, the drawings which need to be used in the description of the embodiments will be briefly described below. Obviously, the drawings described below are just some embodiments of the present invention. One skilled in the art may further obtain other drawings according to these drawings without contributing any creative work.

FIG. 1 illustrates a structural schematic diagram of a nonmetallic conductive geotextile in one embodiment according to the present invention.

FIG. 2 illustrates a structural schematic diagram of a nonmetallic conductive geotextile in another embodiment according to the present invention.

FIG. 3 illustrates one structural schematic diagram of a nonmetallic conductive geotextile in another embodiment according to the present invention.

FIG. 4 illustrates another structural schematic diagram of a nonmetallic conductive geotextile in another embodiment according to the present invention.

FIG. 5 illustrates one structural schematic diagram of a geocomposite in one embodiment according to the present invention.

FIG. 6 illustrates another structural schematic diagram of a geocomposite in one embodiment according to the present invention.

### DESCRIPTION OF COMPONENT MARK NUMBERS

100 Nonmetallic conductive geotextile
110 Geotextile
120 Conductive coating
130 Conductive fiber
200 Geocomposite
210 Geonet
300 Nonconductive geotextile
400 Conductive sewing thread
500 Nonwoven fabric

### DETAILED DESCRIPTION OF THE PREFERRED EMBODIMENTS

The implementation modes of the present invention will be described below through specific embodiments. One skilled in the art may easily understand other advantages and effects of the present invention according to the content disclosed by the description.

Please refer to FIGS. 1-6. It shall be understood that the structures, scales, sizes and the like illustrated in the attached drawing of the description are only used for cooperating with the contents disclosed by the description to allow one skilled in the art to understand and read instead of limiting the implementable limitation conditions of the present invention, and thus have no technical substantive meanings; and any structural modifications, changes of scaling relations or adjustments to sizes shall still fall into the scope which can be covered by the technical contents disclosed by the present invention under the situation that the effects which can be produced by the present invention and the purposes which can be achieved by the present invention are not influenced. In addition, words such as “above”, “below”, “left”, “right”, “middle” and “one” cited in the description are just used for facilitating clear description instead of limiting the implementable scope of the present invention. Changes or adjustments of relative relations thereof shall also be deemed as the implementable scope of the present invention under the situation that the technical contents are not substantively changed.

The purpose of the embodiment according to the present invention is to provide a nonmetallic conductive geotextile and a geocomposite, which are used for solving the problem that conductive geotextiles cannot resist acid and alkali and resist electrochemical corrosion when metals are used as conductive materials in the prior art. The principle and implementation modes of the nonmetallic conductive geotextile and the geocomposite provided by the present invention will be described below in detail such that one skilled in the art can understand the nonmetallic conductive geotextile and the geocomposite provided by the present invention without contributing any creative work.

### Embodiment 1

Please refer to FIG. 1. This embodiment provides a nonmetallic conductive geotextile 100. The nonmetallic conductive geotextile 100 comprises a geotextile110 and a nonmetallic conductive structure connected with the geotextile 110, and the geotextile 110 has a conductive function through the nonmetallic conductive structure. In this embodiment, a conductive material used for the geotextile 110 is a nonmetallic material, and the geotextile 110 made in this way has functions such as aging resistance, corrosion resistance, acid and alkali resistance and electrochemical corrosion resistance, and can be adapted to severe environments. Specifically, in this embodiment, the nonmetallic conductive structure comprises one of carbon nanotube, graphene, superconductive carbon black or a combination thereof.

Specially, as illustrated in FIG. 1, in this embodiment, the nonmetallic conductive structure is continuous conductive coating 120 formed by mixture of one of the carbon nanotube, the graphene, the superconductive carbon black or a combination thereof, and a binder, and the conductive coating 120 is coated onto the surface of the geotextile 110.

Herein, the conductive coating 120 is coated onto one surface or two surfaces of the geotextile 110.

The binder is a high-molecular binder and the content of the high-molecular binder is 1%-99%. The surface resistivity of the conductive coating 120 is required to satisfy a requirement of conductor. In this embodiment, the surface resistivity of the conductive coating 120 is smaller than 10⁵ ohms/square area.

In this embodiment, the conductive coating 120 is coated onto the surface of the geotextile by means of but not limited to spray coating, roller coating, roll coating, dip coating or brush coating to form a conductive layer stable and with uniform thickness.

In other words, in this embodiment, the nonmetallic conductive structure is made of carbon nanotube, graphene or superconductive carbon black with high conductive performance and a high-molecular binder. In this way, the nonmetallic conductive structure has excellent electrical performance and chemical corrosion resistance performance. The conductive material may be a single conductive material or mixture of several materials. Preferably, the conductive coating 120 is formed by the carbon nanotube and the high-molecular binder. Herein, for example, the high-molecular binder is acrylic, polyurethane or epoxy resin etc., and preferably is a water-borne acrylic binder. An addition ratio of the binder is within 5-80% and is conventionally 20-30%.

An implementation process of this embodiment is as follows: one of carbon nanotube, graphene, superconductive carbon black or a combination thereof is mixed with the high-molecular binder, and the mixture is coated onto the surface of the geotextile 110 by means of spray coating, roller coating, roll coating, dip coating or brush coating to form the uniform conductive coating 120, wherein the geotextile 110 may be an existing polypropylene geotextile, polyester geotextile or a geotextile 110 made from any other materials.

### Embodiment 2

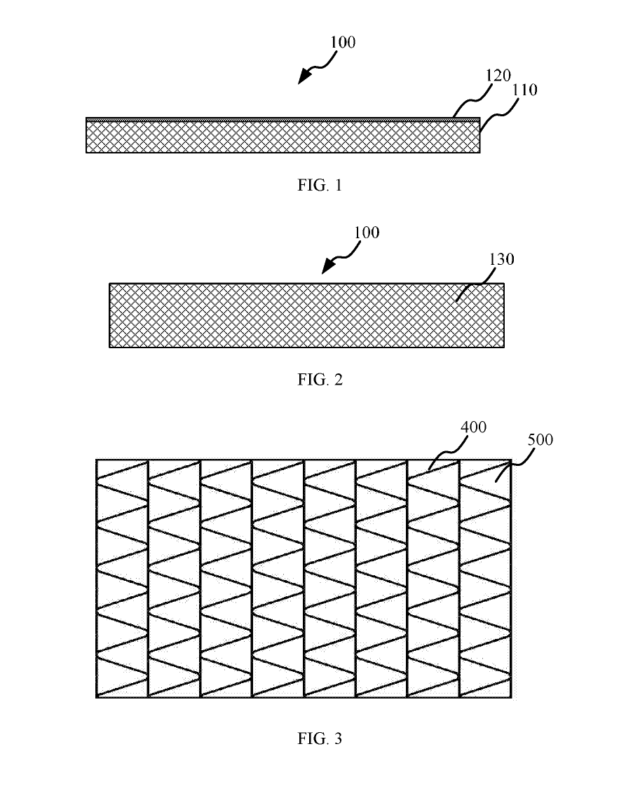

Please refer to FIG. 2. This embodiment provides a nonmetallic conductive geotextile 100. The nonmetallic conductive geotextile 100 comprises a geotextile 110 and a nonmetallic conductive structure connected with the geotextile 110, and the geotextile 110 has a conductive function through the nonmetallic conductive structure. In this embodiment, a conductive material used for the geotextile 110 is a nonmetallic material, and the geotextile 110 made in this way has functions such as aging resistance, corrosion resistance, acid and alkali resistance and electrochemical corrosion resistance, and can be adapted to severe environments.

Specifically, in this embodiment, the nonmetallic conductive structure comprises one of carbon nanotube, graphene, superconductive carbon black or a combination thereof.

Specifically, as illustrated in FIG. 2, in this embodiment, the nonmetallic conductive structure is a conductive fiber 130 made from one of the carbon nanotube, the graphene, the superconductive carbon black or a combination thereof, and plastic particles; the conductive fiber 130 is a nonmetallic conductive fiber, and when the geotextile 110 is made, the conductive fiber 130 is added and connected into the geotextile 110 to form a nonmetallic conductive blended geotextile.

In other words, one of the carbon nanotube, the graphene, the superconductive carbon black or a combination thereof is added into the plastic particles to form the conductive fiber 130, and the conductive fiber 130 is blended with a common fiber to form a nonmetallic conductive blended geotextile.

Wherein, the content of the added conductive fiber 130 is 5%-10%. In other words, the geotextile 110 may be fully made of the conductive fiber 130 to form the nonmetallic conductive geotextile 100.

The surface resistivity of the formed nonmetallic conductive blended geotextile is required to satisfy requirement of conductor. In this embodiment, the surface resistivity of the nonmetallic conductive blended geotextile is smaller than 10⁵ ohms/square area. In other words, in this embodiment, the nonmetallic conductive structure is a conductive fiber 130 made from one of carbon nanotube, graphene, superconductive carbon black or a combination thereof. In this way, the nonmetallic conductive structure has excellent electrical performance and chemical corrosion resistance performance. The conductive material may be a single conductive material or mixture of several materials, a conductor fiber made of carbon nanotube is preferred.

An implementation process of this embodiment is as follows:

The conductive fiber 130 is made from one of carbon nanotube, graphene, superconductive carbon black or a combination thereof, and when producing the geotextile 110, the conductive fiber 130 is added, wherein the content of the added conductive fiber 130 is 5%-10%, such that the conductive fiber 130 is connected into the geotextile 110 to form a nonmetallic conductive blended geotextile.

### Embodiment 3

This embodiment provides a nonmetallic conductive geotextile 100. The nonmetallic conductive geotextile 100 comprises a geotextile 110 and a nonmetallic conductive structure connected with the geotextile 110, and the geotextile 110 has a conductive function through the nonmetallic conductive structure. In this embodiment, a conductive material used for the geotextile 110 is a nonmetallic material, and the geotextile 110 made in this way has functions such as aging resistance, corrosion resistance, acid and alkali resistance and electrochemical corrosion resistance, and can be adapted to severe environments.

Specifically, in this embodiment, the nonmetallic conductive structure comprises one of carbon nanotube, graphene, superconductive carbon black or a combination thereof.

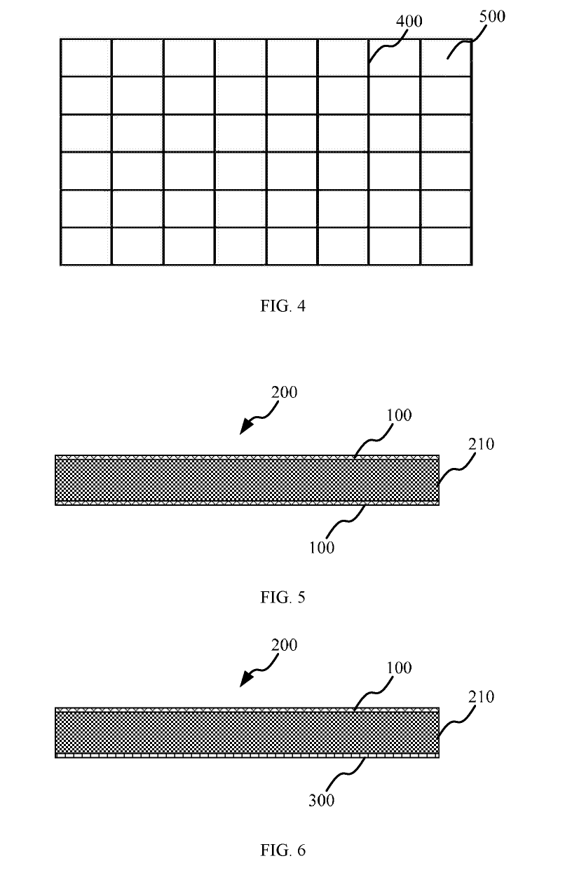

Specifically, as illustrated in FIG. 3 and FIG. 4, in this embodiment, the nonmetallic conductive structure is a conductive sewing thread 400 made from a high-molecular polymer added with one of the carbon nanotube, the graphene, the superconductive carbon black or a combination of, or is a conductive sewing thread 400 made by a common sewing thread which is dip-coated with a high-molecular polymer added with one of the carbon nanotube, the graphene, the superconductive carbon black or a combination of Wherein, the high-molecular polymer is polypropylene, polyethylene, dacron, polyacrylic fiber or polytetrafluoroethylene etc., for example, and preferably is polypropylene or polytetrafluoroethylene which has good acid and alkali resistance performance.

When forming the geotextile, the conductive sewing thread 400 is sewn onto a nonwoven fabric 500 at regular intervals to form a nonmetallic conductive geotextile.

In this embodiment, the conductive sewing thread 400 is formed in two ways as follows:

1) One of the carbon nanotube, the graphene, the superconductive carbon black or a combination thereof with a high-molecular binder added is dip-coated onto the surface of a sewing thread, such that the sewing thread is conductive, thereby a conductive sewing thread 400 is formed, then the conductive sewing thread 400 is sewn onto the surface of a nonwoven fabric 500 at regular intervals to form a conductive geotextile.

2) One of the carbon nanotube, the graphene, the superconductive carbon black or a combination thereof is added into a high-molecular plastic material, then a sewing thread is made through spinning to form a conductive sewing thread 400, and then the conductive sewing thread 400 is sewn onto the surface of a nonwoven fabric 500 at regular intervals to form a conductive geotextile.

The surface resistivity of the conductive sewing thread 400 is smaller than 10⁵ ohms/square area.

Wherein, the conductive sewing threads 400 are uniformly sewed on the nonwoven fabric 500, the distance between the conductive sewing threads 400 is between 1 mm-500 mm; if the distance between the conductive sewing thread 400 is too large, the leaking liquid may not immerse the conductive sewing threads 400, thereby leakage cannot be found in time; if the distance is too small, the cost of the product will be increased.

As illustrated in FIG. 3 and FIG. 4, the conductive sewing threads 400 are arranged on the nonwoven fabric 500 in several geometric shapes such as rhombus and square formed through cross stitching.

Specifically, as illustrated in FIG. 3, the conductive sewing threads 400 are arranged on the nonwoven fabric 500 in a shape of rhombus formed through cross stitching. As illustrated in FIG. 4, the conductive sewing threads 400 are arranged on the nonwoven fabric 500 in a shape of square or rectangle formed through cross stitching.

### Embodiment 4

As illustrated in FIG. 5 and FIG. 6, this embodiment of the present invention provides a geocomposite 200, the geocomposite 200 comprises a geonet 210 and the nonmetallic conductive geotextile 100 according to any one of embodiments bonded to one surface or two surfaces of the geonet 210, the geocomposite 200 with a conductive function is formed by the geonet 210 and the nonmetallic conductive geotextile 100, and since the nonmetallic conductive geotextile 100 is made from a nonmetallic material and has functions such as aging resistance, corrosion resistance, acid and alkali resistance and electrochemical corrosion resistance, the geocomposite 200 has excellent conductive performance and acid and alkali resistance performance. When the geocomposite 200 is applied to a position between two layers of geomembranes, a conductive layer is formed between the two layers of geomembranes, such that leakage detection and long-term leakage monitoring systems can be both realized, a clay layer is replaced, the clay layer or other natural conductive material is not used, which prevents the compaction of laying clay layer from damaging the lower layer of geomembrane, the deformation of the clay layer due to foundation settlement which may result in the damage of the structural layer and the damage of the leakage-proof structure is avoided, thus the construction is convenient to perform, the structural layer also becomes simple, the conductive geocomposite 200 can be used for comparatively steep side slopes, this effect cannot be achieved by using natural clay, omitting the clay layer will increase the reservoir capacity.

Specifically, as illustrated in FIG. 5, for example, one structure of the geocomposite 200 comprises a geonet 210 and the nonmetallic conductive geotextiles 100 according to any one of embodiments 1-3 bonded to two surfaces of the geonet 210. In other words, the double surfaces of the geonet 210 are bonded with the nonmetallic conductive geotextiles 100.

For another example, as illustrated in FIG. 6, another structure of the geocomposite 200 comprises a geonet 210 and the nonmetallic conductive geotextile 100 bonded to one surface of the geonet 210 as described above. In other words, the nonmetallic conductive geotextile 100 is bonded to the one surface of the geonet 210 is bonded with the nonmetallic conductive geotextile 100.

In this embodiment, when the nonmetallic conductive geotextile 100 is bonded to one surface of the geonet 210, as illustrated in FIG. 4, a metallic conductive geotextile or nonconductive geotextile 300 is bonded to the other surface of the geonet 210, and preferably, the nonconductive geotextile 300 is bonded to the other surface of the geonet 210.

In this embodiment, the geocomposite 200 is used between two layers of geomembranes in the dual-layer leakage-proof structure. For damage loophole detection after construction completion, the geocomposite 200 forms a uniform conductive layer such that the accuracy of loophole detection is improved. In long-term leakage detection system, monitoring electrodes can be directly arranged on the geocomposite 200, and the uniform conductive layer enables the sensitivity and accuracy of the long-term monitoring system to be kept higher. By using the geocomposite 200, the clay layer or other natural conductive material may not be used, and damage of the low layer geomembrane caused by constructing the clay layer will be avoided. By using the geocomposite 200, the leakage-proof structure layer becomes simple, and the damage loophole detection and long-term leakage monitoring after construction are more reliable.

To sum up, in the present invention, by connecting the nonmetallic conductive structure into the geotextile to form the nonmetallic conductive geotextile, the problem that geotextiles cannot resist acid and alkali and resist electrochemical corrosion when metals are used as conductive materials is avoided; in addition, in the present invention, by bonding the nonmetallic conductive geotextile onto the surface of the geonet to enable the geonet to form a uniform conductive layer; when the geonet is applied to the detection of damage loophole detection after construction completion, the accuracy of loophole detection can be effectively improved; and besides, the material is mainly used for the long-term monitoring system of the geomembrane leakage-proof structure. Therefore, the present invention effectively overcomes various disadvantages in the prior art and thus has a very great industrial utilization value.

The above-mentioned embodiments are just used for exemplarily describing the principle and effect of the present invention instead of limiting the present invention. One skilled in the art may make modifications or changes to the above-mentioned embodiments without departing from the spirit and scope of the present invention. Therefore, all equivalent modifications or changes made by those who have common knowledge in the art without departing from the spirit and technical thought disclosed by the present invention shall be still covered by the claims of the present invention.

What is claimed is:

1. A nonmetallic conductive geotextile, characterized in that the nonmetallic conductive geotextile comprises a geotextile and a nonmetallic conductive structure connected with the geotextile, and the nonmetallic conductive structure comprises one of carbon nanotube, graphene, superconductive carbon black or a combination thereof.

2. The nonmetallic conductive geotextile according to claim 1, characterized in that the nonmetallic conductive structure is a conductive coating formed by mixture of one of carbon nanotube, graphene, superconductive carbon black or a combination thereof, and a binder, and the conductive coating is coated onto one surface or two surfaces of the geotextile.

3. The nonmetallic conductive geotextile according to claim 2, characterized in that the conductive coating is coated onto the surface of the geotextile by means of spray coating, roller coating, roll coating, dip coating or brush coating to form a uniform conductive layer.

4. The nonmetallic conductive geotextile according to claim 2, characterized in that the surface resistivity of the conductive coating is smaller than 10⁵ ohms/square area.

5. The nonmetallic conductive geotextile according to claim 1, characterized in that the nonmetallic conductive structure is a conductive sewing thread formed by high-molecular polymer added with one of the carbon nanotube, the graphene, and the superconductive carbon black or a combination thereof, or is a conductive sewing thread formed by a common sewing thread which is dip-coated with a high-molecular polymer added with one of the carbon nanotube, the graphene, superconductive carbon black or a combination thereof; and when producing the geotextile, the conductive sewing thread is sewn onto a nonwoven fabric at regular intervals to form a nonmetallic conductive geotextile.

6. The nonmetallic conductive geotextile according to claim 5, characterized in that the sewing distance of the conductive sewing thread on the nonwoven fabric is 1 mm-500 mm; and the surface resistivity of the conductive sewing thread is smaller than 10⁵ ohms/square area.

7. The nonmetallic conductive geotextile according to claim 1, characterized in that the nonmetallic conductive structure is a conductive fiber formed by one of the carbon nanotube, the graphene, the superconductive carbon black or a combination thereof, and plastic particles; and when producing the geotextile, the conductive fiber is added and connected into the geotextile to form a nonmetallic conductive blended geotextile.

8. The nonmetallic conductive geotextile according to claim 7, characterized in that the content of the added conductive fiber is 5%-100%.

9. The nonmetallic conductive geotextile according to claim 7, characterized in that the surface resistivity of the nonmetallic conductive blended geotextile is smaller than 10⁵ ohms/square area.

10. A geocomposite, characterized in that the geocomposite comprises a geonet and the nonmetallic conductive geotextile according to claim 1 which is bonded to one surface or two surfaces of the geonet; and when the nonmetallic conductive geotextile is bonded onto one surface of the geonet, a metallic conductive geotextile or nonconductive geotextile is bonded onto the other surface of the geonet.
